(19) United States
(12) Patent Application Publication
(10) Pub. No.: US 2013/0019894 A1
(43) Pub. Date: Jan. 24, 2013

(54) PLASMA PROCESSING METHOD AND PLASMA ASHING APPARATUS

(71) Applicants: Yutaka KUDOU, Kudamatsu-shi (JP); Shin HIYAMA, Toyama-shi (JP)

(72) Inventors: Yutaka KUDOU, Kudamatsu-shi (JP); Shin HIYAMA, Toyama-shi (JP)

(73) Assignees: Hitachi Kokusai Electric Inc.; Hitachi High-Technologies Corporation

(21) Appl. No.: 13/535,404

(22) Filed: Jun. 28, 2012

(30) Foreign Application Priority Data
Jul. 20, 2011 (JP) 2011-159125

(51) Int. Cl. B08B 7/00; B08B 13/00

(52) U.S. Cl. 134/1.1; 156/345.48

(57) ABSTRACT

In a plasma ashing processing on a sample including a Low-k film, a processing method that can prevent or reduce a film damage on the Low-k film while performing a high speed ashing processing is provided. A plasma processing method for performing a plasma processing on the sample including a Low-k film 15 includes: a step of performing plasma etching on the sample; and a step of performing plasma ashing on the sample including the Low-k film 15 with a resist mask 13, a carbon hard mask 14, and by-products 16 that have been subjected to plasma etching in the plasma etching process by a carbon (C₊) radical 18 and a hydrogen (H₊) radical 20 generated from methane (CH₄) gas 19, using mixed gas including the methane (CH₄) gas 19, which is hydrocarbon gas, and argon (Ar) gas, which is noble gas.

The present application is based on and claims priority of Japanese patent application No. 2011-159125 filed on Jul. 20, 2011, the entire contents of which are hereby incorporated by reference.

### BACKGROUND OF THE INVENTION

1. Field of the Invention

The present invention relates to a plasma processing method and a plasma ashing apparatus, and in particular, to a plasma processing method and a plasma ashing apparatus that prevent a film damage on a low dielectric constant film (hereinafter referred to as “Low-k film”).

2. Description of the Related Art

With respect to a semiconductor device, in order to increase operation speed of a device, a copper wiring and a Low-k film having a relative dielectric constant of 3.0 or lower are used as an interlayer insulating film and a groove on a wafer is filled with metal, before excessive metal is removed by a chemical mechanical polishing method (polishing technique with the use of chemicals), which is a mainstream, damascene process. The relative dielectric constant is a ratio of medium dielectric constant to vacuum dielectric constant. Since faster processing speed is expected in the future, a Low-k film with lower dielectric constant will be required. A Low-k film is generally a compound including SiOC as a main component, and in order to lower relative dielectric constant (k), current attempts include increasing carbon content in the component and making a porous film by providing holes in the film.

When a plasma processing is performed on such a Low-k film, there is a problem that relative dielectric constant of the Low-k film increases due to a film damage on the Low-k film after plasma etching or plasma ashing. Relative dielectric constant of the Low-k film increases because carbons (C) are removed from the SiOC film due to a plasma processing such as etching and ashing, mainly leaving SiO bonds. Also, when fluorine gas is used for an etching or an ashing processing, there is a problem that silicons (Si) are removed from the SiOC film, resulting in the reduced film thickness and lower mechanical strength.

To solve such a problem, Japanese Patent Laid-Open Publication No. 2008-117903 describes a method for restoring film quality of a porous Low-k film by supplying a material having an Si—C—Si bond. Japanese Patent Laid-Open Publication No. 2008-98418 describes a method for repairing a film damage by using a material in which Si—CH₃ group is bonded.

In addition, Japanese Patent Laid-Open Publication No. 9-326298 describes, in a field of etching, a dry etching method in which a member to be etched including zinc (Zn) such as zinc sulfide (ZnS) is easily etched with high etching rate with the use of methane gas and argon gas. Japanese Patent Laid-Open Publication No. 2008-277812 describes a method for ashing a Low-k dielectric material by adding hydrogen, arbitrary nitrogen, a large amount of water vapor, a large amount of argon plasma or helium plasma, and hydrocarbon gas such as methane.

In consideration of the above-described related arts, ashing by methane gas was considered as plasma ashing after plasma etching of a Low-k film.

However, a plasma processing method using methane gas and argon gas described in Japanese Patent Laid-Open Publication No. 9-326298 is an etching method for a member to be etched including Zn such as ZnS, and an ashing processing on an etched sample, especially an etched Low-k film, is not considered. In addition, as for an ashing method using methane gas and argon gas as described in Japanese Patent Laid-Open Publication No. 2008-277812, hydrogen or a large amount of water vapor is included in ashing gas and a film damage on a Low-k film cannot be fully prevented.

Because methane gas is easily deposited, it has been difficult to efficiently supply methane gas from a gas supply unit to a wafer that is subjected to an ashing processing. Therefore, it has been difficult to perform a high speed ashing while preventing a film damage by using methane gas.

An object of the present invention is to solve the above problems and to provide a processing method to prevent or reduce a film damage on a Low-k film while performing a high speed ashing processing, in a plasma ashing processing on a sample including a Low-k film.

### SUMMARY OF THE INVENTION

A plasma processing method according to the present invention is a plasma processing method for performing a plasma processing on a sample including a Low-k film, including a step of performing plasma ashing on the sample that has been subjected to plasma etching in a plasma etching process with the use of mixed gas including hydrocarbon gas and noble gas.

In addition, a plasma processing method according to the present invention uses a plasma ashing apparatus for performing plasma ashing on a sample, the plasma ashing apparatus including: a vacuum process chamber including a dielectric inner cylinder, a gas introducing unit located above the inner cylinder, and a processing housing located below the inner cylinder; an induction coil wound on an outer periphery of the inner cylinder; a radio-frequency power source for supplying radio-frequency electricity to the induction coil; and a stage provided in the vacuum process chamber on which the sample is placed. The sample includes a Low-k film, and plasma ashing is performed on the sample that has been subjected to plasma etching with the use of mixed gas including hydrocarbon gas and noble gas.

Further, a plasma ashing apparatus according to the present invention is a plasma ashing apparatus for performing plasma ashing on a sample, which includes: a vacuum process chamber including a dielectric inner cylinder, a gas introducing unit located above the inner cylinder, and a processing housing located below the inner cylinder; an induction coil wound on an outer periphery of the inner cylinder; a radio-frequency power source for supplying radio-frequency electricity to the induction coil; and a sample stage provided in the vacuum process chamber on which the sample including a Low-k film is placed. The plasma ashing apparatus further includes a unit for placing the sample including a Low-k film that has been subjected to plasma etching on the sample stage and a unit for supplying mixed gas including hydrocarbon gas and noble gas to the sample including a Low-k film placed on the sample stage.

According to a configuration of the present invention, a high speed ashing processing can be performed while preventing or reducing a film damage on a Low-k film.

### BRIEF DESCRIPTION OF THE DRAWINGS

FIG. 1 is a schematic cross-sectional view of a plasma ashing apparatus used for the present invention;

FIG. 2 is a diagram illustrating an exemplary cross-sectional structure of a Low-k film after an etching processing subjected to an ashing processing according to the present invention;

FIG. 3 is a diagram illustrating a reaction model when an ashing processing according to the present invention is performed;

FIG. 4 is a diagram illustrating a reaction model when over ashing is performed after removal of by-products; and

FIG. 5 is a result of evaluation of an amount of loss of film thickness by the present invention.

### REFERENCE SIGNS LIST

1 Top plate
2 Shield
3 Cooling pipe
4 Aluminum chamber
5 Quartz chamber
6 Induction coil
7 Radio-frequency power source
8 Wafer stage
9 Wafer stage support
10 Baffle plate
11 Exhaust unit
12 Ashing gas
13 Resist mask
14 Carbon hard mask
15 Low-k film
16 By-products
17 Argon (Ar) gas
18 Carbon (C+) radical
19 Methane (CH₄) gas
20 Hydrogen (H+) radical
21 Portion of removed carbon (C)

### DETAILED DESCRIPTION OF THE PREFERRED EMBODIMENTS

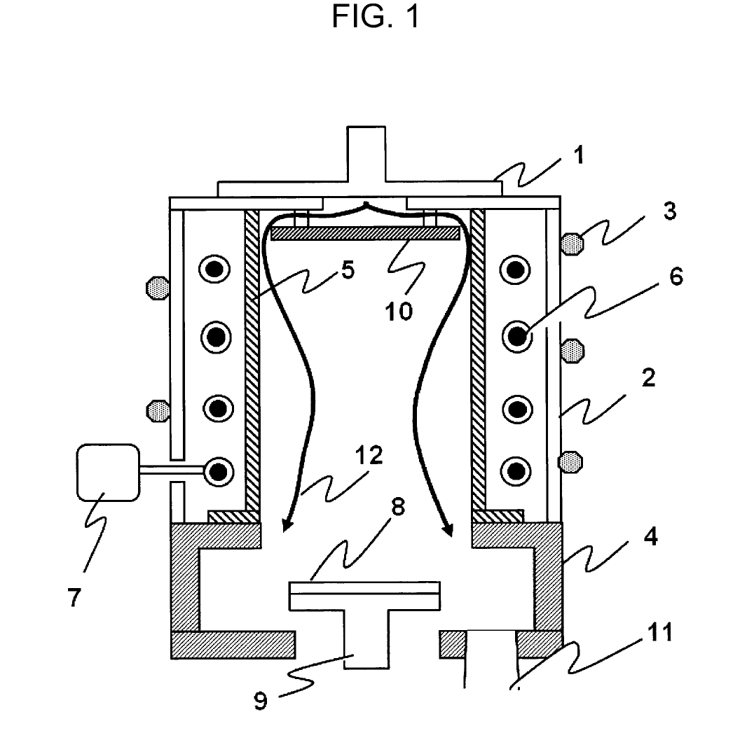

Embodiments of the present invention will be described below with reference to the drawings. FIG. 1 is a schematic cross-sectional view of a plasma ashing apparatus used for the present invention. The plasma ashing apparatus according to the present invention is a helical antenna type down flow ashing device that is an inductively coupled plasma (hereinafter referred to as “ICP”) system, in which a structure is simple and high density plasma is easily obtained.

A vacuum process chamber that generates plasma inside the chamber includes a top plate 1, a quartz chamber 5, an aluminum chamber 4, and the like, which are described below.

The quartz chamber 5 is formed of cylindrical quartz and induction coils 6 are wound on an outer periphery of the quartz chamber 5 at a constant interval. Radio-frequency electricity is supplied from a radio-frequency power source 7 to the induction coils 6 to generate induction field from the induction coils 6. The height of the quartz chamber 5 is optimized such that plasma is uniformly distributed on a wafer, which is a sample placed on a wafer stage 8.

A shield 2 with cooling pipes 3 is provided on an outer periphery of the induction coils 6 to prevent leakage of radio-frequency. Ashing gas 12 is supplied from the center of the top plate 1 that is provided in an upper part of the quartz chamber 5. A baffle plate 10 made of quartz is provided immediately below the top plate 1, and the ashing gas 12 is once dispersed to the outer periphery direction by the baffle plate 10.

After that, the ashing gas 12 dispersed to the outer periphery direction is directed to the wafer, which is the sample placed on the wafer stage 8 located below, along an inner wall of the quartz chamber 5, and the ashing gas 12 is uniformly supplied on a surface of the wafer by plasma diffusion. The ashing gas 12 flows along the inner wall of the quartz chamber 5 to supply the ashing gas 12 near the induction coils 6. Generally, plasma density is high near the induction coils 6 in an ICP type plasma source; therefore, the flow of the ashing gas 12 as described above makes it possible to generate high density plasma.

Since the induction coils 6 are wound in proximity to the outer periphery of the quartz chamber 5 at a constant interval with respect to the longitudinal direction with a central axis of the quartz chamber 5 being the longitudinal direction, it is possible to uniformly control the temperature of the quartz chamber 5 at 200° C. by supplying, for example, 1000 W of radio-frequency electricity to the induction coils 6.

The wafer stage 8 on which the wafer, which is the sample, is placed is provided in the aluminum chamber 4, made of aluminum and supported by a wafer stage support 9. The aluminum chamber 4 is made of aluminum. A surface of the wafer stage 8 has a flat structure without steps so that an end portion of the wafer is not in contact with the wafer stage 8.

In addition, nine alumina pins (not shown) are embedded in the surface of the wafer stage 8, and the structure is such that a back surface of the wafer is not in direct contact with the surface of the wafer stage 8 (i.e. in point contact with the surface of the wafer stage 8) because of the existence of the alumina pins; therefore, reduction in contamination on the back surface of the wafer is sought. Further, a temperature control unit (not shown) for controlling the temperature of the wafer stage 8 is provided, and the temperature of the wafer stage 8 can be controlled from 0° C. to 400° C.

### First Embodiment

An ashing processing using the above-described plasma ashing apparatus will be described below. A wafer including an SiOC film 15 with a mask formed of a laminated structure of a resist mask 13 and a carbon hard mask 14 that has been etched by a plasma etching device is placed on the wafer stage 8 by a conveying unit (not shown).

Methane (CH₄) gas 19 and argon (Ar) gas 17 are supplied to the quartz chamber 5 at a gas flow rate shown in Table 1, and the pressure inside the vacuum process chamber is adjusted to 200 Pa using an exhaust unit 11. Subsequently, 1000 W of radio-frequency electricity is supplied to the induction coils 6 to generate plasma and ashing is performed on the wafer placed on the wafer stage 8. The temperature of the stage during ashing of the wafer is controlled to be 300° C. Ashing is performed only for a predetermined period of time, and after that time has passed, the wafer placed on the wafer stage 8 is carried out from the plasma ashing apparatus by the conveying unit.

TABLE 1

| | | | Radio- | | |
|---|---|---|---|---|---|
| | | | frequency | | Wafer stage |
| CH₄ gas | Ar gas | H₂ gas | electricity | Pressure | temperature |
| (mL/min) | (L/min) | | (W) | (Pa) | (° C.) |
| 50 | 20 | — | 1000 | 200 | 300 |

Ashing can be performed with a flow rate of the argon (Ar) gas 17 being 100 to 1000 times a flow rate of the methane (CH₄) gas 19. In the present embodiment, 400 times is the most suitable. Ashing with a flow ratio of hydrocarbon gas to inert gas being 1:400 is the most suitable for prevention of foreign substances and high ashing rate. Hydrocarbon gas generally has a strong deposition property; therefore, if hydrocarbon gas is excessively supplied, dissociation balance at an ashing processing is degraded and C—H bond-based by-products are generated.

High output radio-frequency electricity is required to achieve higher ashing rate. Since the temperature of an inner surface of the quartz chamber 5 is influenced by the radio-frequency electricity, it is preferable that the radio-frequency electricity is 500 W or higher. If the radio-frequency electricity is below 500 W, the temperature of the quartz chamber 5 does not rise up to 200° C. and higher, and carbon deposition attaches to the inner wall of the quartz chamber 5. In the present embodiment, the radio-frequency electricity is set to be 1000 W in consideration of ashing rate uniformity within the wafer plane.

In the present embodiment, the temperature of the wafer stage 8 is 300° C., but an effect similar to the present invention can be achieved if the temperature is 250° C. or higher. When the temperature is 100° C. or lower, carbon (C) is shifted to the deposition side. When the temperature is below 250° C., it is difficult to achieve both of high ashing rate and better ashing rate uniformity within the wafer plane.

The pressure in the vacuum process chamber is set to be 200 Pa, but an effect similar to the present invention can be achieved if the pressure is in a range between 100 Pa and 500 Pa. When the pressure is below 100 Pa or above 500 Pa, stable discharge cannot be achieved. the present embodiment, ashing is performed for a predetermined period of time; however, if ashing is performed for a period of time with the use of an end point determination by a plasma light-emission detection unit (not shown), a film damage on the SiOC film is further prevented and ashing time can be shortened.

Next, functions of the methane (CH₄) gas 19 and the argon (Ar) gas 17 used in the present embodiment will be described. The methane (CH₄) gas 19 removes by-products 16 on the resist mask 13 or a pattern side wall portion with a hydrogen (H+) radical 20 and the like generated from the methane (CH₄) gas 19. However, since the methane (CH₄) gas 19 has a high attachment coefficient, the methane (CH₄) gas 19 that is excited by plasma is deposited on the inner wall of the quartz chamber 5 and has a difficulty in reaching the wafer placed on the wafer stage 8.

However, when the argon (Ar) gas 17 is supplied to the vacuum process chamber together with the methane (CH₄) gas 19, the methane (CH₄) gas 19 remains in the vacuum process chamber only for a short time and it is possible to cause the methane (CH₄) gas 19 to follow the flow of the argon (Ar) gas 17. Therefore, it is possible to efficiently supply the methane (CH₄) gas 19 on the surface of the wafer.

TABLE 2

| | | | Radio- | | |
|---|---|---|---|---|---|
| | | | frequency | | Wafer stage |
| CH₄ gas | Ar gas | H₂ gas | electricity | Pressure | temperature |
| (mL/min) | (L/min) | | (W) | (Pa) | (° C.) |
| 50 | 20 | 5 | 1000 | 200 | 300 |

### Second Embodiment

When the condition shown in Table 2 is used, ashing rate will be higher than the case where the condition shown in Table 1 is used. However, since a side wall of the Low-k film 15 including SiOC is directly exposed to the hydrogen (H+) radical 20 after a polymer attached to the pattern side wall as a result of plasma etching is removed, a film damage is likely to be exacerbated. Therefore, in order to achieve high ashing rate and to prevent a film damage, ashing may be performed with two steps including the condition shown in Table 2 as a first step and the condition shown in Table 1 as a second step, as shown in Table 3. Nevertheless, even in the case of using the condition shown in Table 2, both of high ashing rate and prevention of a film damage can be achieved if a gas flow rate of each of the argon (Ar) gas 17, the methane (CH₄) gas 19, and hydrogen (H₂) gas is optimized.

TABLE 3

| | | | | Radio- | | |
|---|---|---|---|---|---|---|
| | | Ar | H₂ | frequency | | Wafer stage |
| | CH₄ gas | gas | gas | electricity | Pressure | temperature |
| Step | (mL/min) | (L/min) | | (W) | (Pa) | (° C.) |
| 1 | 50 | 20 | 5 | 1000 | 200 | 300 |
| 2 | 50 | 20 | — | 1000 | 200 | 300 |

In the first step, ashing is performed for a predetermined period of time. In the second step, over ashing is performed to remove a polymer and the like attached to the pattern side wall as a result of plasma etching, that are not fully removed in the first step. Therefore, at that time, the conditions are switched so as to use the hydrocarbon gas and the inert gas only for over ashing, so that a more efficient ashing processing is possible.

If the first step is switched to the second step with the use of the end point determination by the plasma light-emission detection unit (not shown), a film damage on the Low-k film 15 including SiOC is further prevented and ashing time can be shortened. Ashing rate according to the present invention is within a range between approximately 200 and 600 (nm/min), and this is almost equivalent to a conventional ashing process using a mixed gas consisting of H2 gas and N2 gas. Since it is possible to control the ashing rate within this range, depending on a purpose of ashing, it is possible to employ a low rate condition when an end point detection is necessary, and to perform a processing with a high rate condition to remove simple by-products.

TABLE 4

| | 2 Diatomic molecule | | | | | |
|---|---|---|---|---|---|---|
| | C—O | Si—O | Si—C | C—H | O—H | Si—H |
| Binding energy | 257 | 192 | 104 | 81 | 102 | 75 |
| (Kcal/mol) | | | | | | |

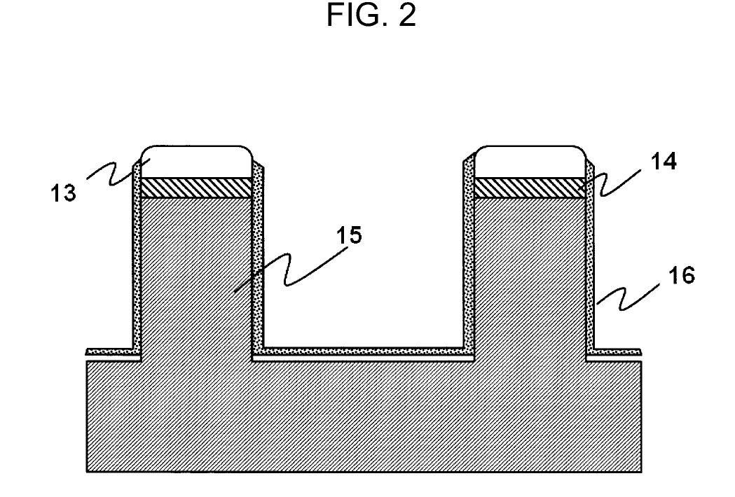

FIGS. 2 to 4 are diagrams illustrating an ashing model according to the present invention. Table 4 shows binding energy of diatomic molecules for explaining the model. FIG. 2 is a diagram illustrating an exemplary cross-sectional structure of the Low-k film 15 after an etching processing. Usually, the Low-k film is a film including an atomic bond of the Low-k film 15 of SiOC, and relative dielectric constant (k) depends on content of carbon (C). The reduction of relative dielectric constant generates the Low-k film 15 by increasing content of carbon (C) in the film.

It is assumed that bonds included in the Low-k film 15 are mainly Si—O: 192 [Kcal/mol], Si—C: 104 [Kcal/mol], and C—O: 257 [Kcal/mol]. By-products 16 on a surface of the Low-k film 15 are a deposition mainly containing a carbon (C+) radical 18 that is generated during an etching processing on the Low-k film 15.

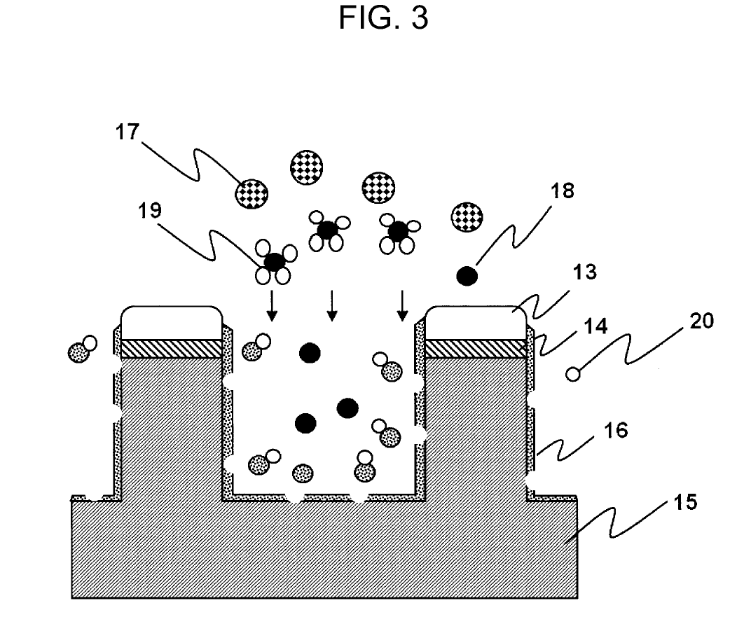

FIG. 3 illustrates a reaction model when an ashing processing is performed under the condition according to the present invention shown in Table 1. At the start of ashing, the hydrogen (H+) radical 20 generated by dissociation of the methane (CH₄) gas 19 is reacted with the component of the carbon (C+) radical 18 included in the by-products 16, and ashing proceeds.

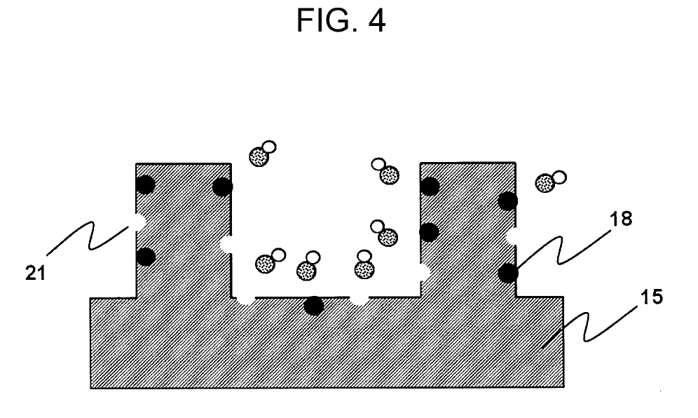

FIG. 4 illustrates a reaction model when over ashing is performed after removal of the by-products 16. Though dependent on an etching condition, it is assumed that a small amount of the carbon (C+) radical 18 is removed from the Low-k film 15 by an etching processing or the hydrogen (H+) radical 20 from the ashing gas, and a dangling bond of silicon (Si) and oxygen (O) is generated.

It is assumed that a bond of the hydrogen (H₊) radical 20 from the methane (CH₄) gas 19 and the carbon (C+) radical 18 from the Low-k film 15 causes a reaction since the bond includes bonds of Si—H: 75 [Kcal/mol], O—H: 102 [Kcal/mol], and C—H: 81 [Kcal/mol] as compared with bond energy of the Low-k film 15 itself described above; however, in terms of simple comparison of bond energy, bond energy of the bond of the hydrogen (H₊) radical 20 from the methane (CH₄) gas 19 and the carbon (C+) radical 18 from the Low-k film 15 is generally lower compared with the bond energy of the Low-k film 15. Therefore, it is assumed that an amount of a portion of removed carbon (C) 21 by the hydrogen (H₊) radical 20 is small. The condition according to the present invention provides a solution to the small amount of the portion of removed carbon (C) 21.

On the surface of the Low-k film 15 after over ashing, the carbon (C+) radical 18 generated by dissociation of the methane (CH₄) gas 19 is adsorbed to the dangling bond of silicon (Si) and oxygen (O) generated due to the portion of removed carbon (C) 21 by the hydrogen (H+) radical 20, thereby forming a bond of Si—C or C—O and the surface of the Low-k film 15 becomes stable.

As a result, increase in relative dielectric constant can be prevented. In this reaction, the hydrogen (H+) radical 20 also exists due to dissociation of the methane (CH₄) gas 19. However, since bond energy of Si—C and C—O is much stronger than bond energy of O—H and Si—H, carbon (C) in the Low-k film 15 is not removed again by the hydrogen (H+) radical 20.

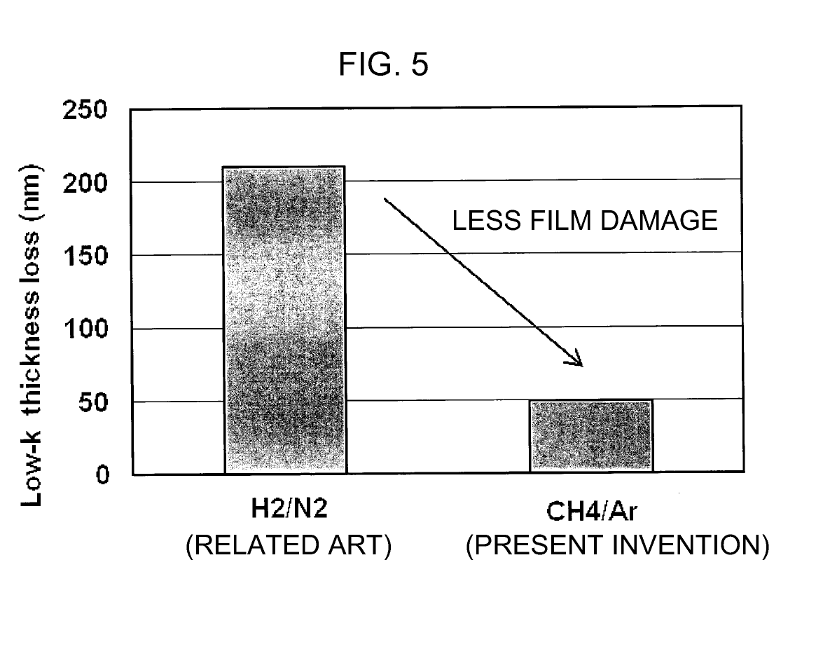

FIG. 5 illustrates a result of comparison between the present invention and a related art with respect to an amount of loss of film thickness from the Low-k film. The Low-k film relative dielectric constant of which is 2.5 is processed for 60 seconds under the condition according to the present invention shown in Table 1 and the condition of H₂/N₂, and the amount of loss of film thickness is compared. Under the condition according to the present invention, the amount of loss of film thickness from the Low-k film 15 is 50 nm, which is smaller compared with the condition of H₂/N₂. This means that a film damage is prevented in the present invention compared with the related art.

In this verification, the wafer is vertically irradiated with plasma; however, as for a wafer for an actual device, since the Low-k film 15 is a pattern and the carbon hard mask 14 is on the pattern, the pattern side wall side is exposed to plasma. Therefore, the amount of loss of film thickness is several nm.

As described above, by performing ashing with the use of the argon (Ar) gas 17 together with the methane (CH₄) gas 19, a supply of the methane (CH₄) gas 19 to the wafer is improved, and a film damage on the Low-k film is prevented or reduced while performing a high speed ashing. In addition, in the ashing method with mixed gas including the argon (Ar) gas 17 and the methane (CH₄) gas 19 using an ashing device used in the present invention, when radio-frequency electricity supplied to the induction coils 6 is set to be 1000 W or higher, the supply of the methane (CH₄) gas 19 to the wafer becomes easy and further improvement in ashing rate is expected.

In addition, since ashing is performed with not the wafer being in contact with the entire surface of the wafer stage 8 in the present embodiment, plasma is directed also to the back surface of the wafer. Therefore, a deposition attached to an end portion (bevel portion) of the wafer and a back surface of the wafer end portion by the plasma etching processing can be removed and metal contamination can also be prevented.

The methane (CH₄) gas 19 is used in the present embodiment; however, an effect similar to the present embodiment can be achieved by using hydrocarbon gas such as ethane and propane. In addition, an effect similar to the present embodiment can be achieved by using noble gas such as xenon and krypton instead of the argon (Ar) gas 17 used in the present embodiment. Further, though an SiOC film is used as the Low-k film 15, an effect similar to the present embodiment can be achieved by using a carbon-containing film such as an organic film as the Low-k film 15.

What is claimed is:

1. A plasma processing method for performing a plasma processing on a sample including a Low-k film, comprising:
a step of performing plasma ashing on the sample that has been subjected to plasma etching in a plasma etching process, using a mixed gas including a hydrocarbon gas and a noble gas.

2. The plasma processing method according to claim 1, wherein the hydrocarbon gas is a methane gas and the noble gas is an argon gas.

3. A plasma processing method using a plasma ashing apparatus for performing plasma ashing on a sample, the plasma ashing apparatus comprising:
a vacuum process chamber including a dielectric inner cylinder, a gas introducing unit located above the inner cylinder, and a processing housing located below the inner cylinder;
an induction coil wound on an outer periphery of the inner cylinder;
a radio-frequency power source for supplying radio-frequency electricity to the induction coil; and
a sample stage provided in the vacuum process chamber on which the sample is placed, and wherein:
the sample includes a Low-k film; and
plasma asking is performed on the sample that has been subjected to plasma etching, using a mixed gas including a hydrocarbon gas and a noble gas.

4. The plasma processing method according to claim 3, wherein the hydrocarbon gas is a methane gas and the noble gas is an argon gas.

5. The plasma processing method according to claim 3, wherein:
the hydrocarbon gas is a methane gas and the noble gas is an argon gas; and
a gas flow ratio of the mixed gas including the methane gas and the argon gas is 1:100 or more.

6. The plasma processing method according to claim 3, wherein:
the hydrocarbon gas is a methane gas and the noble gas is an argon gas; and
the radio-frequency electricity supplied to the induction coil is 1000 W or higher.

7. The plasma processing method according to claim 3, wherein:
the hydrocarbon gas is a methane gas and the noble gas is an argon gas;
1000 W or higher of radio-frequency electricity is supplied to the induction coil; and
a temperature of the sample stage is controlled to be 250° C. or higher.

8. A plasma processing method for performing a plasma processing on a sample including a Low-k film, comprising:
a step of performing plasma ashing on the sample that has been subjected to plasma etching in a plasma etching process, using a mixed gas including a hydrocarbon gas, a noble gas, and a hydrogen gas.

9. A plasma ashing apparatus for performing plasma ashing on a sample including a Low-k film, comprising:
a vacuum process chamber including a dielectric inner cylinder, a gas introducing unit located above the inner cylinder, and a processing housing located below the inner cylinder;
an induction coil wound on an outer periphery of the inner cylinder;
a radio-frequency power source for supplying radio-frequency electricity to the induction coil; and
a sample stage provided in the vacuum process chamber on which the sample including a Low-k film is placed, the plasma ashing apparatus further comprising:
a unit for placing the sample including a Low-k film that has been subjected to plasma etching on the sample stage; and
a unit for supplying a mixed gas including a hydrocarbon gas and a noble gas to the sample including a Low-k film placed on the sample stage.
